(19) United States
(12) Patent Application Publication
(10) Pub. No.: US 2010/0278150 A1
(43) Pub. Date: Nov. 4, 2010

(54) METHOD FOR INTER RAT HANDOVER

(76) Inventors: Gi Won Park, Gyeonggi-do (KR); Jin Lee, Seoul (KR); Yong Ho Kim, Inchen-si (KR); Ki Seon Ryu, Gyeonggi-do (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/810,502

(22) PCT Filed: Dec. 24, 2008
(86) PCT No.: PCT/KR2008/007677

§ 371 Date: Jun. 24, 2010

(30) Foreign Application Priority Data
Dec. 31, 2007 (KR) 10-2007-0141393

(51) Int. Cl. H04W 36/00; H04W 36/30

(52) U.S. Cl. 370/332

(57) ABSTRACT

A method for inter RAT handover is disclosed. The method for inter RAT handover comprises measuring cell quality of WiMAX neighbor cells from a user equipment of E-UTRAN and transmitting the measured result to an origin base station; and if RRC message is received from the origin base station, the RRC message including WiMAX signal, pre-registering with a target WiMAX base station using tunneling based on second layer protocol. Therefore, the user equipment can continue to receive a service with maintaining current service quality even though the user equipment moves to a heterogeneous network. In addition, it is possible to reduce the time required for the user equipment to perform handover to the target base station. Moreover, if there is a failure of a radio link when the user equipment performs handover, it is possible to enable fast recovery.

### TECHNICAL FIELD

The present invention relates to inter-radio access technology (RAT) handover, and more particularly, to a method for improving speed and reliability during handover from E-UTRAN of 3GPP to WiMAX of IEEE.

### BACKGROUND ART

Inter RAT(radio access technology) handover means a technology for improving user convenience by providing a seamless service to a user equipment even though the user equipment moves to a heterogeneous network other than a network with which the user equipment is registered.

FIG. 1 and FIG. 2 are diagrams illustrating examples of a procedure of performing handover in a user equipment from E-UTRAN to UTRAN.

FIG. 1 is a diagram illustrating an example of a preparation step corresponding to a part of a procedure of performing handover in a user equipment from E-UTRAN to UTRAN.

A base station eNodeB determines movement (inter RAT handover) of a user equipment to a neighbor cell if quality of the neighbor cell is better than that of a current cell based on a measurement report message transmitted from the user equipment (110).

The origin base station which has determined inter RAT handover of the user equipment transmits a relocation required message to a mobility management entity (MME) to request the MME to establish a resource required to perform handover in a core network, i.e., target SGSN (120).

The MME transmits a forward relocation request message to the target SGSN (130). The forward relocation request message includes PDP context information corresponding to radio bearer information established in the origin system, and a parameter value used for data transfer between the MME and a serving gateway (GW).

The target SGSN which has received the forward relocation request message from the MME transmits a relocation request message to a target RNC (140) to request radio bearer information required for the user equipment to perform handover. The target RNC which has received the relocation request message transmits a relocation request acknowledgment message to the target SGSN, wherein the relocation request acknowledgement message includes the information requested from the target SGSN (145).

The target SGSN and the serving GW create a radio bearer by exchanging create bearer request/response messages with each other (150, 155).

The target SGSN is allocated with a resource from the target RNC, creates the serving GW and the radio bearer, and transmits a forward relocation response message to the MME (160). In this case, the forward relocation response message includes information received through the messages of 145 and 155.

FIG. 2 is a diagram illustrating an example of an execution step corresponding to a part of a procedure of performing handover in a user equipment from E-UTRAN to UTRAN.

The MME which has received the forward relocation response message transmits a relocation command message to the origin base station to complete the handover preparing procedure (210).

The origin base station which has received the relocation command message from the MME transmits a handover command message (HO from E-UTRAN command) to the user equipment so as to request movement to the target cell (220).

The origin base station transmits serving radio network subsystem (SRNS) context to the MME so that the target SGSN and the target RNC can identify SRNS context information (230-234).

The user equipment moves to a target cell (UTRAN) and accesses the target cell using the parameter value included in the second step message. After accessing the target cell, the user equipment transmits a handover to UTRAN complete message to the target RNC (240-241). After this time, the user equipment can transmit uplink data to the target base station.

The target RNC which has received the handover to UTRAN complete message notifies the target SGSN, through a relocation complete message, that the user equipment has completed handover and accessed the target base station (250).

The target SGSN which has received the relocation complete message notifies the MME that the user equipment has completely performed handover to the target base station (260-261), and requests the serving GW to update radio bearer information (270).

The serving GW which has received the update bearer request message from the target SGSN transfers the update bearer request message to a PDN GW so as to update the radio bearer information (280-281).

The serving GW which has received the update bearer response message from the PDN GW transmits a bearer update response message to the target SGSN (290). Afterwards, downlink user data received from the PDN GW and uplink data transmitted to the outside, which have been previously transmitted from and received to the origin base station, have been transmitted from and received to the target RNC. Namely, path switching is made.

If the MME receives the forward relocation complete message (260) from the target SGSN, the MME transmits a resource release message to the base station (298). The origin base station releases its resource possessed to perform communication with the user equipment.

The user equipment transmits a routing area update request message to the target SGSN to perform routing area update.

Inter-RAT handover according to the related art has been developed to support mobility between heterogeneous networks within the same standard requirements. The technology for supporting Inter-RAT handover within different standard requirements is being currently developed. According to the related art, since the user equipment should perform a registration procedure during initial access to the target base station after completing handover, a problem occurs in that handover is delayed.

### DISCLOSURE

### Technical Problem

Accordingly, the present invention is directed to a method for inter-RAT handover, which substantially obviates one or more problems due to limitations and disadvantages of the related art.

An object of the present invention is to provide a method for inter-RAT handover, which can promptly support reliable inter-RAT handover to a target base station.

### Technical Solution

To achieve the object and other advantages and in accordance with the purpose of the invention, as embodied and broadly described herein, a method for inter RAT handover comprises measuring cell quality of WiMAX neighbor cells from a user equipment of E-UTRAN and transmitting the measured result to an origin base station; and if RRC message is received from the origin base station, the RRC message including WiMAX signal, pre-registering with a target WiMAX base station using tunneling based on second layer protocol.

Preferably, the RRC message is obtained by capsulating the WiMAX signal using a subheader including message type representing inter RAT handover and ID of the target base station.

Preferably, the WiMAX signal includes MAC header for WiMAX and WiMAX payload.

Preferably, the step of transmitting the measured result includes measuring quality of the inter RAT cell if signal quality of a serving cell is less than a signal quality threshold value for measuring signal quality of the WiMAX cell or if receiving power strength of the serving cell is less than receiving power threshold value for measuring receiving power of the WiMAX cell.

Preferably, the signal quality threshold value and the receiving power threshold value can be included in system information periodically received from the origin base station.

Preferably, the step of pre-registering with the target base station includes pre-registering with the target base station if signal quality of a serving cell is less than a pre-registration signal quality threshold value or if receiving power strength of the serving cell is less than pre-registration receiving power threshold value.

In another aspect of the present invention, a method for inter RAT handover comprises measuring cell quality of WiMAX neighbor cells from a user equipment of E-UTRAN and transmitting the measured result to an origin base station; and if RRC message is received from the origin base station, the RRC message including WiMAX signal, pre-registering with a target WiMAX base station using tunneling based on third layer protocol.

Preferably, the RRC message is obtained by capsulating the WiMAX signal using an IP header including IP address of an inter RAT access node.

Preferably, the WiMAX signal includes MAC header for WiMAX and WiMAX payload.

Preferably, the step of transmitting the measured result includes measuring quality of the inter RAT cell if signal quality of a serving cell is less than a signal quality threshold value for measuring signal quality of the WiMAX cell or if receiving power strength of the serving cell is less than receiving power threshold value for measuring receiving power of the WiMAX cell.

Preferably, the signal quality threshold value and the receiving power threshold value can be included in system information periodically received from the origin base station.

Preferably, the step of pre-registering with the target base station includes pre-registering with the target base station if signal quality of a serving cell is less than a pre-registration signal quality threshold value or if receiving power strength of the serving cell is less than pre-registration receiving power threshold value.

In other aspect of the present invention, a method for inter RAT handover comprises measuring cell quality of WiMAX neighbor cells from a user equipment of E-UTRAN and transmitting the measured result to an origin base station; if handover initiate command, which includes ID of a target base station, is received from the origin base station and the target base station is the base station with which the user equipment has been pre-registered, transmitting a handover preparation complete message to the origin base station; and if the handover preparation complete message is received from the origin base station, performing an initial access procedure with the target base station.

Preferably, the handover initiate command and the handover preparation complete message include identifier of the user equipment, which is given from a cell managed by the origin base station.

Preferably, the step of transmitting the handover preparation complete message to the origin base station includes pre-registering with the target base station using tunneling based on second layer protocol if the target base station is not the base station with which the user equipment has been pre-registered.

Preferably, the step of transmitting the handover preparation complete message to the origin base station includes pre-registering with the target base station through an inter RAT access node using tunneling based on third layer protocol if the target base station is not the base station with which the user equipment has been pre-registered.

Preferably, the step of transmitting the handover preparation complete message to the origin base station includes: transmitting a handover request message to an inter RAT access node using tunneling based on third layer protocol if the target base station is not the base station with which the user equipment has been pre-registered; and pre-registering with the target base station by transmitting a handover indication message to the inter RAT access node if a handover response message is received from the inter RAT access node.

Preferably, the step of performing an initial access procedure includes disconnecting from the serving cell and synchronizing with the target base station if a handover preparation complete acknowledgement message is received.

### ADVANTAGEOUS EFFECTS

According to the embodiments of the present invention, the user equipment can continue to receive a service with maintaining current service quality even though the user equipment moves to a heterogeneous network. In addition, it is possible to reduce the time required for the user equipment to perform handover to the target base station. Moreover, if there is a failure of a radio 1 ink when the user equipment performs handover, it is possible to enable fast recovery.

### DESCRIPTION OF DRAWINGS

FIG. 1 is a diagram illustrating a handover preparation procedure between E-UTRAN and UTRAN;

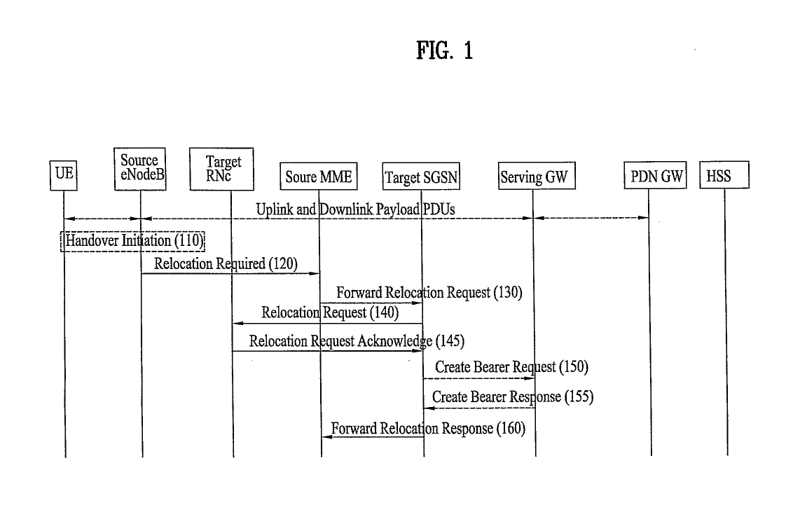

FIG. 2 is a diagram illustrating a handover execution procedure between E-UTRAN and UTRAN;

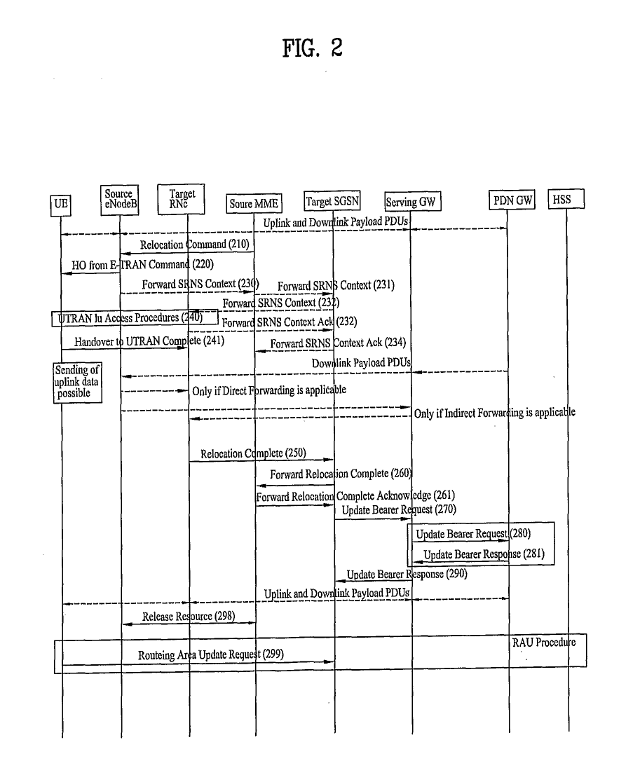

FIG. 3 is a diagram illustrating an example of RRC message applied to one embodiment of the present invention;

FIG. 4 is a diagram illustrating a pre-registration procedure of a method for inter-RAT handover according to one embodiment of the present invention;

FIG. 5 is a diagram illustrating an example of RRC message applied to another embodiment of the present invention;

FIG. 6 is a diagram illustrating a pre-registration procedure of a method for inter-RAT handover according to another embodiment of the present invention;

FIG. 7 is a diagram illustrating a signal flow of a method for inter-RAT handover according to another embodiment of the present invention;

FIG. 8 is a diagram illustrating a signal flow of a method for inter-RAT handover according to another embodiment of the present invention if a user equipment is not pre-registered;

FIG. 9 is a diagram illustrating a signal flow of a method for inter-RAT handover according to still another embodiment of the present invention;

FIG. 10 is a diagram illustrating a signal flow of a method for inter-RAT handover according to still another embodiment of the present invention if a user equipment is not pre-registered; and

FIG. 11 is a diagram illustrating a signal flow of a method for inter-RAT handover according to another embodiment of the present invention if an existing handover signal is used.

### BEST MODE

Hereinafter, the preferred embodiments of the present invention will be described with reference to the accompanying drawings. However, it is to be understood that various modifications can be made in the following embodiments of the present invention, and the scope of the present invention is not limited to the following embodiments.

Hereinafter, handover between a user equipment and a target base station will be described based on a procedure of performing pre-registration with a target base station before performing handover and a procedure of performing real handover between an origin base station and a target base station.

According to the embodiments of the present invention, the user equipment previously performs a pre-registration procedure with the target base station before performing handover. Also, in order to support inter-RAT handover of different standard requirements, correction should be made in the inter-RAT handover procedure according to the related art. Moreover, a new handover signaling message is additionally provided.

The embodiments of the present invention support that the user equipment can previously be registered with WiMAX base station before performing handover from E-UTRAN cell to WiMAX cell.

A second layer tunneling (L2 Tunneling) applied to one embodiment of the present invention uses frames in a unit of transmission based on a second protocol (data link layer). All payloads are transmitted through an inter-network, for example, a network entity of a network which is currently registered, by capsulation of PPP frame.

A third layer tunneling (L3 Tunneling) applied to another embodiment of the present invention uses packets in a unit of transmission based on a third protocol (network layer). In this case, IP packets are capsulated by additional IP header and then transmitted through an IP inter-network.

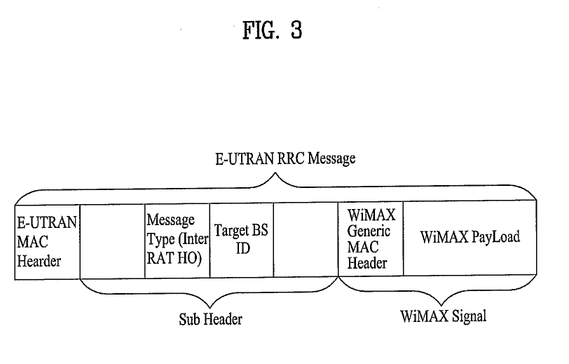

FIG. 3 is a diagram illustrating an example of E-UTRAN RRC signaling message transmitted through second layer tunneling to perform pre-registration before a user equipment performs handover to WiMAX cell.

As illustrated in FIG. 3, the user equipment which is registered with E-URTRAN cell transmits WiMAX signal message to the target WiMAX base station through an intermediate node, for example, base station, MME, and ASN gateway, by capsulating the WiMAX signal message in the E-UTRAN RRC message. A subheader of the E-UTRAN RRC message includes message type representing handover between heterogeneous networks and ID of the target base station. Also, the WiMAX signal includes MAC header for WiMAX and WiMAX payload.

The intermediate node identifies ID of the target base station and transmits a message to another intermediate node so that the message is transferred to the WiMAX base station corresponding to a final destination. Namely, when the user equipment transmits initial packets, the subheader is added to the initial packets. In this case, the intermediate node transfers the packets to next intermediate node by identifying ID of the base station included in the subheader, so that the corresponding packets are transferred to the destination.

The user equipment registered with the E-UTRAN can perform pre-registration with the target WiMAX base station before performing cell reselection or handover. The method for performing pre-registration of the user equipment with the target WiMAX base station is varied depending on the status of the user equipment. In other words, pre-registration of the user equipment, which is performed before cell reselection in an idle state (LTE_IDLE), allows the user equipment to spontaneously perform pre-registration with the target WiMAX base station. Also, pre-registration of the user equipment, which is performed before handover in an active state (LTE_ACTIVE), may allow the user equipment to spontaneously perform pre-registration with the target WiMAX base station, like the idle state, and may allow the user equipment to perform pre-registration with the target WiMAX base station after the base station commands the user equipment to perform pre-registration.

Whether the user equipment starts pre-registration with WiMAX neighbor cell is determined by a threshold value received from the base station. If cell quality of E-UTRAN serving base station, which is measured by the user equipment, is less than the threshold value, the user equipment determines pre-registration with the WiMAX neighbor cell.

Examples of threshold values determining whether to satisfy conditions include a threshold value (LTE-WiMAX start pre-registration signal quality threshold, hereinafter, referred to as ‘first threshold value’) of signal quality of E-UTRAN, which starts pre-registration with WiMAX cell, and a threshold value (LTE-WiMAX start pre-registration Rx power strength threshold, hereinafter, referred to as ‘second threshold value’) of a receiving power strength of E-UTRAN, which starts pre-registration with WiMAX cell.

In other words, if the measured signal quality of the serving cell is smaller than or equal to the first threshold value, or if the measured receiving power strength of the serving cell is smaller than or equal to the second threshold value, the user equipment starts pre-registration with the WiMAX cell.

After determining pre-registration, the user equipment determines the target WiMAX cell based on cell quality of neighbor WiMAX cell, which is measured by the user equipment. The threshold values are fixed values of the base station to support pre-registration with the WiMAX, and are periodically transmitted from the base station to the user equipment through system information for cell reselection in an idle state. Table 1 represents an example of the system information.

TABLE 1

| Title | Description |
|---|---|
| WiMAX RAT Identifier | This field contains the identifier |
| | of WiMAX RAT among the RAT IDs (e.g. |
| | GSM, CDMA 20001X, etc). |
| WiMAX Start Measuring | This field contains the threshold |
| E-UTRAN Signal Quality | of the signal Quality of the current |
| Threshold | cell to trigger WiMAX measurements |
| WiMAX Start Measuring | This field contains the threshold |
| E-UTRAN Rx Power | of the Rx Power Strength of the |
| Strength Threshold | current cell to trigger WiMAX |
| | measurements |
| LTE-WiMAX Start | This field contains the threshold |
| Pre-registration Signal | of the signal Quality of the current |
| Quality threshold | cell to trigger WiMAX |
| | Pre-registration |
| LTE-WiMAX Start | This field contains the threshold |
| Pre-registration Rx | of the Rx Power Strength of the |
| Power Strength threshold | current cell to trigger WiMAX |
| | Pre-registration |

If the above conditions are satisfied, the user equipment in an idle state determines a cell having the best cell quality as a target WiMAX cell among WiMAX neighbor cells measured by itself and starts pre-registration with the target cell. Preferably, the LTE-WiMAX start pre-registration threshold value may be greater than the WiMAX start measuring threshold value.

Meanwhile, the WiMAX neighbor cells will be measured as follows.

The user equipment measures attributes of cells included in a WiMAX neighbor cell list received through the system information for information of neighbor cells by using the following threshold values and conditions. Examples of the threshold values used for measurement of WiMAX neighbor cells include a threshold value (WiMAX start measuring E-UTRAN signal quality threshold, hereinafter, referred to as ‘third threshold value’) of signal quality of E-UTRAN, which starts measurement in WiMAX cell, and a threshold value (WiMAX start measuring E-UTRAN Rx power strength threshold, hereinafter, referred to as ‘fourth threshold value’) of a receiving power strength of E-UTRAN, which starts measurement in WiMAX cell. In other words, if the measured signal quality of the serving cell is smaller than or equal to the third threshold value, or if the measured receiving power strength of the serving cell is smaller than or equal to the fourth threshold value, the user equipment starts measurement of the WiMAX cell. Meanwhile, the third threshold values and the fourth threshold values are broadcasted from the E-UTRAN base station to the user equipment through the system information for cell reselection.

Meanwhile, pre-registration, which is performed before the user equipment performs handover to the WiMAX cell in an active state, may be performed spontaneously by the user equipment, or may be performed by the E-UTRAN base station.

Hereinafter, the pre-registration performed by the E-UTRAN base station will be described.

The user equipment periodically transmits a measurement report to the E-UTRAN base station. If quality of the serving cell, which is reported from the user equipment, is less than the first threshold value and the second threshold value, the E-UTRAN base station identifies quality of the WiMAX cell, which is reported by the user equipment. The E-UTRAN base station selects WiMAX cell having the best cell quality as a target WiMAX cell with which the user equipment will perform pre-registration, and notifies the user equipment of the selected WiMAX cell through RRC signaling message. For example, the E-UTRAN base station includes a flag for pre-registration in the RRC signaling message so that the user equipment performs pre-registration if indication information indicates 1 and does not perform pre-registration if not so.

Hereinafter, the pre-registration procedure of the user equipment will be described in detail.

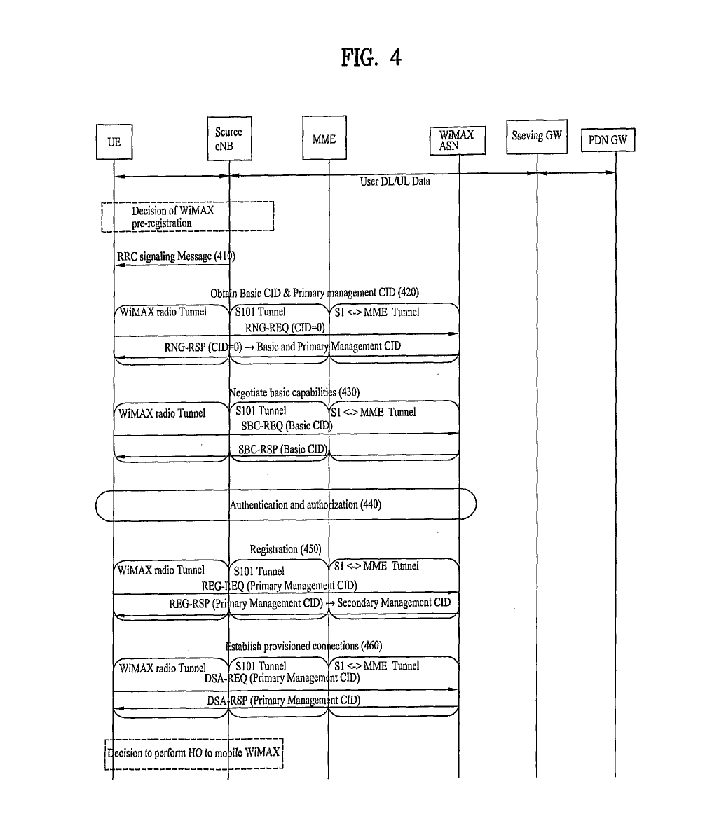

FIG. 4 is a diagram illustrating a pre-registration procedure based on second layer tunneling before a user equipment performs handover from E-UTRAN cell to WiMAX cell.

If the base station determines that pre-registration with the WiMAX cell is needed before the user equipment performs handover to WiMAX cell in an active state, the base station notifies the user equipment, through the RRC signaling message, that pre-registration is needed (410).

The user equipment obtains basic CID and primary management CID through ranging request/response messages with the target WiMAX base station (420). Since signaling through WiMAX air interface is not performed in this step, timing offset and power parameter adjustment procedures cannot be performed, wherein the timing offset and power parameter adjustment procedures have been performed through RNG-REQ/RSP through WiMAX air interface according to the related art.

The user equipment performs a negotiation procedure of basic capabilities with the WiMAX base station (430).

After performing authentication and authorization procedures (440), the user equipment performs a registration procedure with the WiMAX base station (450).

The user equipment transmits a DSA-REQ message to the target WiMAX base station and receives acknowledgement to establish a new service flow with the target WiMAX base station (460).

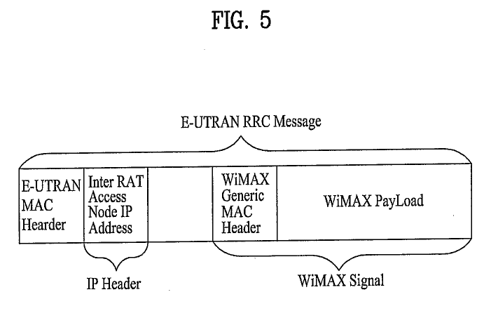

FIG. 5 is a diagram illustrating an example of E-UTRAN RRC message transmitted through third layer tunneling to perform pre-registration when a user equipment performs handover to WiMAX cell.

As illustrated in FIG. 5, IP header includes IP address of an access node between heterogeneous networks. The user equipment which is registered with E-URTRAN cell transmits WiMAX signal message to an inter RAT access node through an IP inter-network by capsulating the WiMAX signal message in the E-UTRAN RRC message. Afterwards, the inter RAT access node transmits the message to the target WiMAX base station by identifying ID of the WiMAX base station of the WiMAX signal. In this case, the inter RAT access node is a network entity having a function supporting inter RAT handover from E-UTRAN to WiMAX through the third layer tunneling.

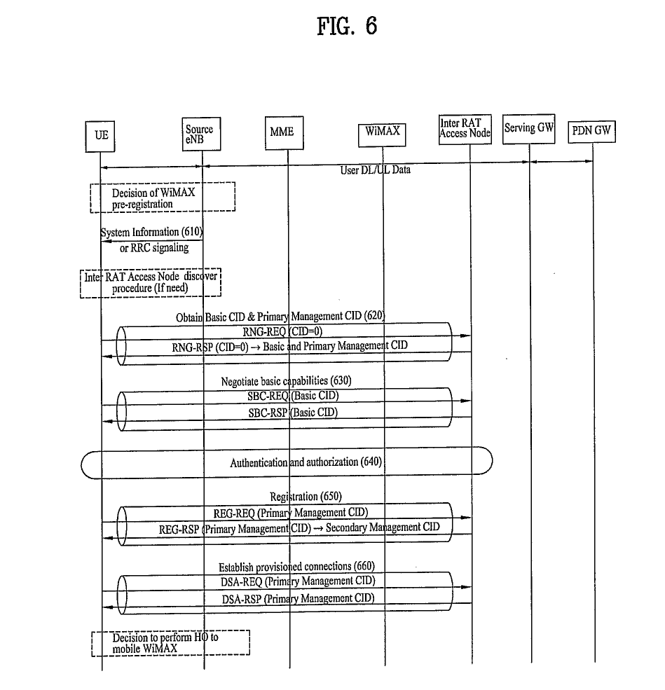

FIG. 6 is a diagram illustrating a pre-registration procedure based on third layer tunneling before a user equipment performs handover from E-UTRAN cell to WiMAX cell.

Unlike second layer tunneling, according to pre-registration based on third layer tunneling, the user equipment performs pre-registration through the inter RAT access node for supporting inter RAT handover.

If the base station determines that pre-registration with the WiMAX cell is needed before the user equipment performs handover to WiMAX cell in an active state, the base station notifies the user equipment, through the system information or the RRC signaling message, whether pre-registration starts (610). If the user equipment does not know IP address of the inter RAT access node, the user equipment performs a retrieval procedure of the inter RAT access mode.

The user equipment obtains basic CID and primary management CID through ranging request/response messages with the target WiMAX base station (620).

The user equipment performs a negotiation procedure of basic capabilities with the WiMAX base station through the inter RAT access node (630).

After performing authentication and authorization procedures (640), the user equipment performs a registration procedure with the WiMAX base station (650).

Finally, the user equipment transmits a DSA-REQ message to the target WiMAX base station and receives acknowledgement through the inter RAT access node to establish a new service flow with the target WiMAX base station (660).

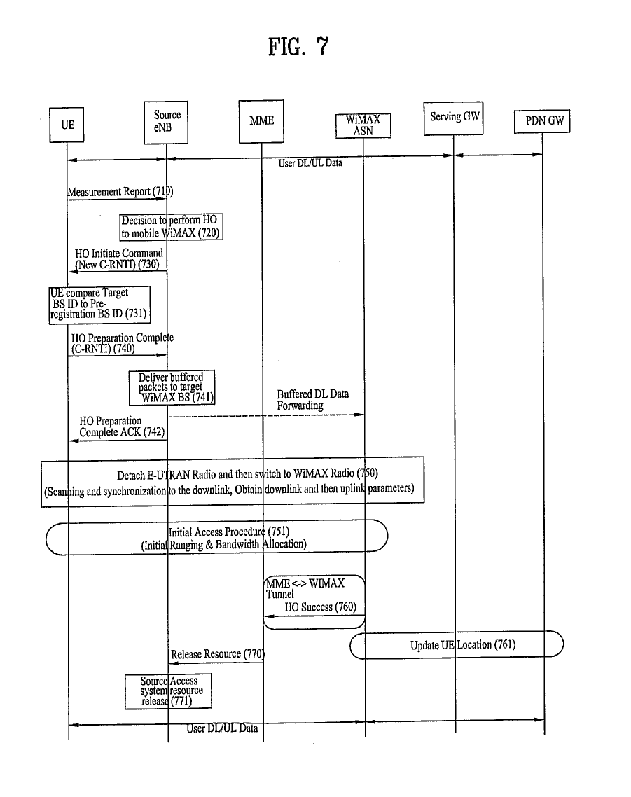

FIG. 7 is a diagram illustrating a handover procedure of a user equipment from E-UTRAN to WiMAX, wherein the user equipment is pre-registered with a target WiMAX base station.

The user equipment periodically transmits a measurement report message to a serving base station (S-eNB) (710).

The base station which has received the measurement report message from the user equipment identifies the message and then determines handover to WiMAX cell if quality of the E-UTRAN cell is not better than that of the WiMAX cell (720). Also, the base station transmits a handover initiate command message to the user equipment, wherein the handover initiate command message includes ID of the target WiMAX base station (730). Examples of the handover initiate command message are as illustrated in Table 2.

TABLE 2

| Parameter title | |
|---|---|
| Message Type | Meaning description |
| C-RNTI | Identifier given from a cell managed by eNB to |
| | identify UE |
| Target WiMAX BS ID | Unique identifier identifying a target WiMAX |
| | base station |

In FIG. 7, since the user equipment performs pre-registration before performing handover, the origin base station does not transmit the HO REQ message to the target base station even though handover is determined but transmits a handover initiate command message to the user equipment, wherein the handover initiate command message includes new CRNTI and ID of the target base station where the user equipment should perform handover.

The user equipment which has received the handover initiate command message from the base station identifies ID of the target WiMAX base station included in the message and checks whether the target WiMAX base station is a base station with which the user equipment has been pre-registered (731).

After the user equipment identifies ID of the target WiMAX base station from the handover initiate command message received from the base station (731), if the target WiMAX base station has been already pre-registered with the user equipment, the user equipment transmits a handover preparation complete (HO preparation complete) message to the base station (740). An example of the handover preparation complete message is as illustrated in Table 3.

TABLE 3

| Parameter title | |
|---|---|
| Message Type | Meaning description |
| C-RNTI | Identifier given from a cell managed by eNB |
| | to identify UE |
| Target WiMAX BS ID | Unique identifier identifying a target WiMAX |
| | base station |
| Target WiMAX ASN | ID of Gateway managing a target WiMAX base |
| GW ID | station |

As the user equipment notifies the origin base station using the handover preparation complete message that handover to the target base station has been completely prepared, the user equipment can transfer the downlink user data transferred from the external IP network before path switching to the target base station. If acknowledgement is received in response to the handover preparation complete message, the user equipment can exactly disconnect radio connection from the origin base station.

The base station which has received the handover preparation complete message identifies CRNTI within the message and compares the CRNTI within the handover preparation complete message with the CRNTI of the handover initiate command message. Then, if the CRNTI within the handover preparation complete message is identical with the CRNTI of the handover initiate command message, the base station transmits a handover preparation complete acknowledgement (HO preparation complete ACK) message to the user equipment in response to the handover preparation complete message (742). Also, the base station transfers downlink packets in a serving buffer to the target WiMAX base station (741).

After receiving the handover preparation complete acknowledgement message from the base station, the user equipment disconnects from the serving cell and synchronizes with the target WiMAX base station (750). In this step, the user equipment scans a downlink channel of a target WiMAX cell, which can be monitored, and downlink-synchronizes with the target WiMAX base station. At this time, the user equipment needs DL-MAP & LCD message and UL-MAP & UCD message, and obtains downlink and uplink parameters through these messages, wherein the downlink and uplink parameters are required for the user equipment to transmit and receive data.

After synchronizing with the target WiMAX base station, the user equipment performs an initial access procedure (751). First of all, the user equipment adjusts timing offset and power parameters by performing initial ranging with the target WiMAX base station, and if there are data to be transmitted to and received from downlink and uplink, the user equipment transmits and receives the data by receiving a bandwidth. At this time, since the user equipment which has been pre-registered with the WiMAX base station can access the target base station by simplifying a network entry procedure, handover latency can be reduced.

If the user equipment completes the initial access procedure with the target WiMAX base station, the target WiMAX base station transmits a handover success (HO success) message to the MME to notify the MME that the user equipment has completed handover to the target base station (760). Also, the target WiMAX base station updates a user data transmission path through path switching (761).

If the handover success message is received from the WiMAX access network, the MME transmits a release resource message to the origin base station to request the origin base station to release a resource for communication with the user equipment (770). The origin base station which has received the release resource message releases the resource (771).

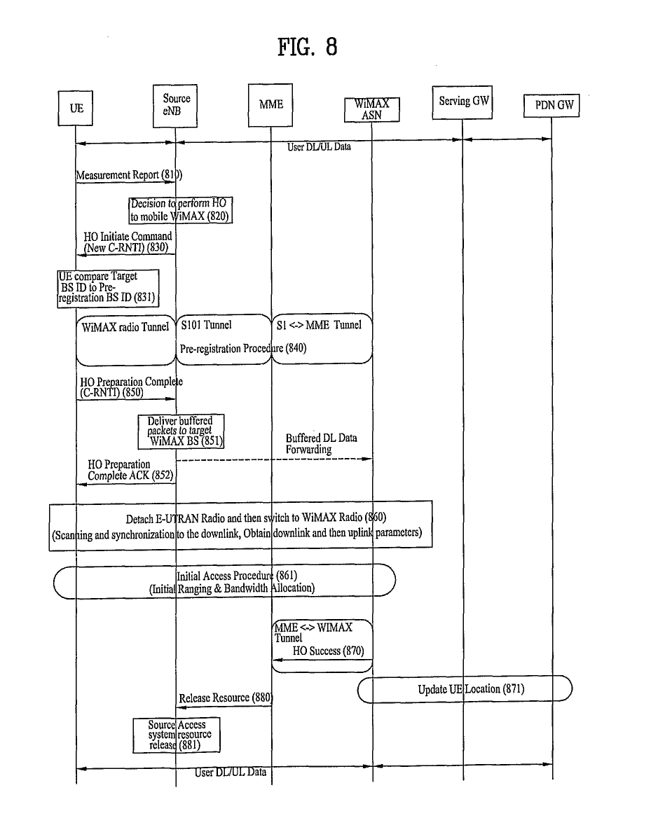

FIG. 8 is a diagram illustrating a handover procedure of a user equipment from E-UTRAN to WiMAX, wherein the user equipment is not pre-registered with a target WiMAX base station.

The user equipment periodically transmits a measurement report message to a serving base station (S-eNB) (810).

The base station which has received the measurement report message from the user equipment identifies the message and then determines handover to WiMAX cell if quality of the E-UTRAN cell is not better than that of the WiMAX cell (820). Also, the base station transmits a handover initiate command message to the user equipment, wherein the handover initiate command message includes ID of the target WiMAX base station and new CRNTI value (830).

The user equipment which has received the handover initiate command message from the base station identifies ID of the target WiMAX base station, which is included in the message, and checks whether the target WiMAX base station is the base station with which the user equipment has been pre-registered (831).

If the target WiMAX base station within the handover initiate command message is not the base station with which the user equipment has been pre-registered, the user equipment performs a pre-registration procedure with the WiMAX base station through second layer tunneling (840).

If the pre-registration procedure between the user equipment and the target WiMAX base station ends, the user equipment transmits a handover preparation complete message to the serving base station (850). The base station which has received the handover preparation complete message identifies CRNTI within the message and compares the CRNTI within the handover preparation complete message with the CRNTI of the handover initiate command message. Then, if the CRNTI within the handover preparation complete message is identical with the CRNTI of the handover initiate command message, the base station transmits a handover preparation complete acknowledgement message to the user equipment in response to the handover preparation complete message (852). Also, the base station which has received the handover preparation complete message transfers downlink packets in a buffer to the target WiMAX base station (851).

After receiving the handover preparation complete acknowledgement message from the base station, the user equipment disconnects from the serving cell and synchronizes with the target WiMAX base station (860). In this step, the user equipment scans a downlink channel of a target WiMAX cell, which can be monitored, and downlink-synchronizes with the target WiMAX base station. At this time, the user equipment needs DL-MAP & LCD message and UL-MAP & UCD message, and obtains downlink and uplink parameters through these messages, wherein the downlink and uplink parameters are required for the user equipment to transmit and receive data.

After synchronizing with the target WiMAX base station, the user equipment performs an initial access procedure (861). First of all, the user equipment adjusts timing offset and power parameters by performing initial ranging with the target WiMAX base station, and if there are data to be transmitted to and received from downlink and uplink, the user equipment transmits and receives the data by receiving a bandwidth.

If the user equipment completes the initial access procedure with the target WiMAX base station, the target WiMAX base station transmits a handover success (HO success) message to the MME to notify the MME that the user equipment has completed handover to the target base station (870). Also, the target WiMAX base station updates a user data transmission path through path switching (871).

If the handover success message is received from the WiMAX access network, the MME transmits a release resource message to the origin base station to request the origin base station to release a resource for communication with the user equipment (880). The origin base station which has received the release resource message releases the resource (881).

The third layer based handover supports inter RAT handover from E-UTRAN to WiMAX through an inter RAT access node.

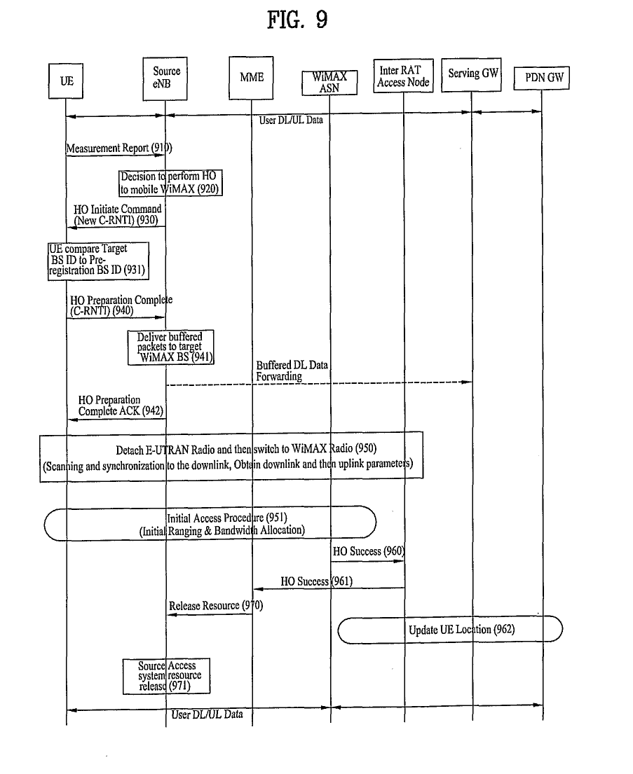

FIG. 9 is a diagram illustrating a handover procedure of a user equipment from E-UTRAN to WiMAX through third layer tunneling, wherein the user equipment is pre-registered with a target WiMAX base station.

The user equipment periodically transmits a measurement report message to a serving base station (S-eNB) (910).

The base station which has received the measurement report message from the user equipment identifies the message and then determines handover to WiMAX cell if quality of the E-UTRAN cell is not better than that of the WiMAX cell (920). Also, the base station transmits a handover initiate command message to the user equipment, wherein the handover initiate command message includes ID of the target WiMAX base station and new CRNTI value (930). The user equipment which has received the handover initiate command message from the base station identifies ID of the target WiMAX base station, which is included in the message, and checks whether the target WiMAX base station is the base station with which the user equipment has been pre-registered (931).

After checking ID of the target WiMAX base station from the handover initiate command message received from the base station (931), if the target WiMAX base station is the base station with which the user equipment has been pre-registered, the user equipment transmits a handover preparation complete message to the base station (940). The base station which has received the handover preparation complete message identifies CRNTI within the message and compares the CRNTI within the handover preparation complete message with the CRNTI of the handover initiate command message. Then, if the CRNTI within the handover preparation complete message is identical with the CRNTI of the handover initiate command message, the base station transmits a handover preparation complete acknowledgement message to the user equipment in response to the handover preparation complete message (942). Also, the base station which has received the handover preparation complete message transfers downlink packets in a buffer to the target WiMAX base station through an inter RAT access node (941).

After receiving the handover preparation complete acknowledgement message from the base station, the user equipment disconnects from the serving cell and synchronizes with the target WiMAX base station (950). In this step, the user equipment scans a downlink channel of a target WiMAX cell, which can be monitored, and downlink-synchronizes with the target WiMAX base station. At this time, the user equipment needs DL-MAP & LCD message and UL-MAP & UCD message, and obtains downlink and uplink parameters through these messages, wherein the downlink and up link parameters are required for the user equipment to transmit and receive data.

After synchronizing with the target WiMAX base station, the user equipment performs an initial access procedure (951). First of all, the user equipment adjusts timing offset and power parameters by performing initial ranging with the target WiMAX base station, and if there are data to be transmitted to and received from downlink and uplink, the user equipment transmits and receives the data by receiving a bandwidth.

If the user equipment completes the initial access procedure with the target WiMAX base station, the target WiMAX base station transmits a handover success (HO success) message to the inter RAT access node to notify the inter RAT access node that the user equipment has completed handover to the target base station (961). The inter RAT access node which has received the handover success message transfers the handover success message to the MME, and updates a user data transmission path through path switching (962).

If the handover success message is received from the inter RAT access node, the MME transmits a release resource message to the origin base station to request the origin base station to release a resource for communication with the user equipment (970). The origin base station which has received the release resource message releases the resource (971).

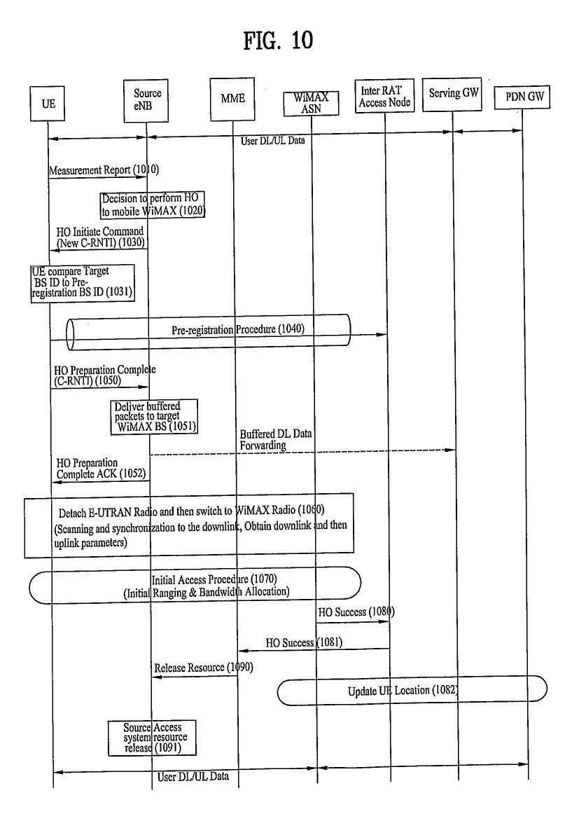

FIG. 10 is a diagram illustrating a handover procedure of a user equipment from E-UTRAN to WiMAX through third layer tunneling, wherein the user equipment is not pre-registered with a target WiMAX base station.

The user equipment periodically transmits a measurement report message to a serving base station (S-eNB) (1010).

The base station which has received the measurement report message from the user equipment identifies the message and then determines handover to WiMAX cell if quality of the E-UTRAN cell is not better than that of the WiMAX cell (1020). Also, the base station transmits a handover initiate command message to the user equipment, wherein the handover initiate command message includes ID of the target WiMAX base station and new CRNTI value (1030). The user equipment which has received the handover initiate command message from the base station identifies ID of the target WiMAX base station, which is included in the message, and checks whether the target WiMAX base station is the base station with which the user equipment has been pre-registered (1031).

If the target WiMAX base station within the handover initiate command message is not the base station with which the user equipment has been pre-registered, the user equipment performs a pre-registration procedure with the target WiMAX base station through an inter RAT access node based on the third layer based tunneling (1040).

The user equipment transmits a handover indication (HO IND) message to the inter RAT access node and then transmits a handover preparation complete message to a serving base station (1050). The base station which has received the handover preparation complete message identifies CRNTI within the message and compares the CRNTI within the handover preparation complete message with the CRNTI of the handover initiate command message. Then, if the CRNTI within the handover preparation complete message is identical with the CRNTI of the handover initiate command message, the base station transmits a handover preparation complete acknowledgement message to the user equipment in response to the handover preparation complete message (1052). Also, the base station which has received the handover preparation complete message transfers downlink packets in a buffer to the target WiMAX base station through the inter RAT access node (1051).

After receiving the handover preparation complete acknowledgement message from the base station, the user equipment disconnects from the serving cell and synchronizes with the target WiMAX base station (1060). In this step, the user equipment scans a downlink channel of a target WiMAX cell, which can be monitored, and downlink-synchronizes with the target WiMAX base station. At this time, the user equipment needs DL-MAP & LCD message and UL-MAP & UCD message, and obtains downlink and uplink parameters through these messages, wherein the downlink and uplink parameters are required for the user equipment to transmit and receive data.

After synchronizing with the target WiMAX base station, the user equipment performs an initial access procedure (1070). First of all, the user equipment adjusts timing offset and power parameters by performing initial ranging with the target WiMAX base station, and if there are data to be transmitted to and received from downlink and uplink, the user equipment transmits and receives the data by receiving a bandwidth.

If the user equipment completes the initial access procedure with the target WiMAX base station, the target WiMAX base station transmits a handover success (HO success) message to the inter RAT access node to notify the inter RAT access node that the user equipment has completed handover to the target base station (1080). The inter RAT access node which has received the handover success message transfers the handover success message to the MME (1081), and updates a user data transmission path through path switching (1082).

If the handover success message is received from the inter RAT access node, the MME transmits a release resource message to the origin base station to request the origin base station to release a resource for communication with the user equipment (1090). The origin base station which has received the release resource message releases the resource (1091).

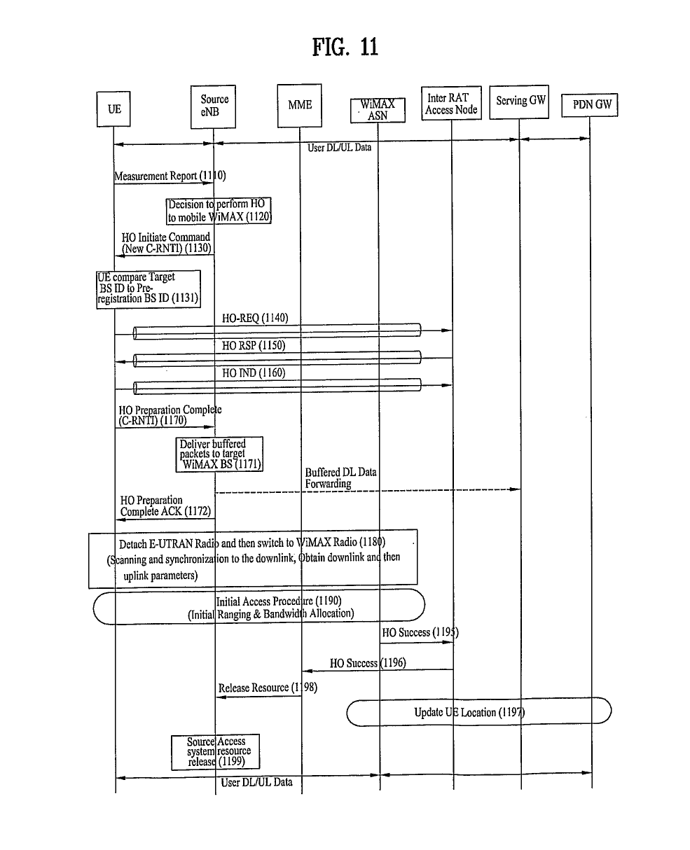

Furthermore, as illustrated in FIG. 11, the existing WiMAX handover signals may be transmitted to the WiMAX base station through third layer tunneling so as to support inter RAT handover between the E-UTRAN and the WiMAX.

The user equipment periodically transmits a measurement report message to a serving base station (S-eNB) (1110).

The base station which has received the measurement report message from the user equipment identifies the message and then determines handover to WiMAX cell if quality of the E-UTRAN cell is not better than that of the WiMAX cell (1120). Also, the base station transmits a handover initiate command message to the user equipment, wherein the handover initiate command message includes ID of the target WiMAX base station and new CRNTI value (1130). The user equipment which has received the handover initiate command message from the base station identifies ID of the target WiMAX base station, which is included in the message, and checks whether the target WiMAX base station is the base station with which the user equipment has been pre-registered (1131).

If the target WiMAX base station within the handover initiate command message is not the base station with which the user equipment has been pre-registered, the user equipment transmits a handover request (HO REQ) message to the inter RAT access node through third layer tunneling (1140). The inter RAT access node transmits a handover response (HO RSP) message to the user equipment in response to the handover request message (1150). The user equipment which has received the handover response message transmits a handover indication (HO IND) message to the inter RAT access node (1160).

After transmitting the handover indication message to the inter RAT access node, the user equipment transmits a handover preparation complete message to the origin base station (1170). The base station which has received the handover preparation complete message identifies CRNTI within the message and compares the CRNTI within the handover preparation complete message with the CRNTI of the handover initiate command message. Then, if the CRNTI within the handover preparation complete message is identical with the CRNTI of the handover initiate command message, the base station transmits a handover preparation complete acknowledgement message to the user equipment in response to the handover preparation complete message (1172). Also, the base station which has received the handover preparation complete message transfers downlink packets in a buffer to the target WiMAX base station through the inter RAT access node (1171).

After receiving the handover preparation complete acknowledgement message from the base station, the user equipment disconnects from the serving cell and synchronizes with the target WiMAX base station (1180). In this step, the user equipment scans a downlink channel of a target WiMAX cell, which can be monitored, and downlink-synchronizes with the target WiMAX base station. At this time, the user equipment needs DL-MAP & LCD message and UL-MAP & UCD message, and obtains downlink and uplink parameters through these messages, wherein the downlink and uplink parameters are required for the user equipment to transmit and receive data.

After synchronizing with the target WiMAX base station, the user equipment performs an initial access procedure (1190). At this time, the user equipment adjusts timing offset and power parameters by performing initial ranging with the target WiMAX base station, and if there are data to be transmitted to and received from downlink and uplink, the user equipment transmits and receives the data by receiving a bandwidth.

If the user equipment completes the initial access procedure with the target WiMAX base station, the target WiMAX base station transmits a handover success (HO success) message to the inter RAT access node to notify the inter RAT access node that the user equipment has completed handover to the target base station (1195). The inter RAT access node which has received the handover success message transfers the handover success message to the MME (1196), and updates a user data transmission path through path switching (1197).

If the handover success message is received from the inter RAT access node, the MME transmits a release resource message to the origin base station to request the origin base station to release a resource for communication with the user equipment (1198). The origin base station which has received the release resource message releases the resource (1199).

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The present invention relates to a method for improving speed and reliability during inter RAT handover, and can be applied to E-UTRAN related apparatuses and algorithms and WiMAX related apparatuses and algorithms.

1. A method for inter RAT handover, the method comprising:
measuring cell quality of WiMAX neighbor cells from a user equipment of E-UTRAN and transmitting the measured result to an origin base station; and
if RRC message is received from the origin base station, the RRC message including WiMAX signal, pre-registering with a target WiMAX base station using tunneling based on second layer protocol.

2. The method of claim 1, wherein the RRC message is obtained by capsulating the WiMAX signal using a subheader including message type representing inter RAT handover and ID of the target base station.

3. The method of claim 1, wherein the WiMAX signal includes MAC header for WiMAX and WiMAX payload.

4. The method of claim 1, wherein the step of transmitting the measured result includes measuring quality of the inter RAT cell if signal quality of a serving cell is less than a signal quality threshold value for measuring signal quality of the WiMAX cell or if receiving power strength of the serving cell is less than receiving power threshold value for measuring receiving power of the WiMAX cell.

5. The method of claim 1, wherein the step of pre-registering with the target base station includes pre-registering with the target base station if signal quality of a serving cell is less than a pre-registration signal quality threshold value or if receiving power strength of the serving cell is less than pre-registration receiving power threshold value.

6. A method for inter RAT handover, the method comprising:
measuring cell quality of WiMAX neighbor cells from a user equipment of E-UTRAN and transmitting the measured result to an origin base station; and
if RRC message is received from the origin base station, the RRC message including WiMAX signal, pre-registering with a target WiMAX base station using tunneling based on third layer protocol.

7. The method of claim 6, wherein the RRC message is obtained by capsulating the WiMAX signal using an IP header including IP address of an inter RAT access node.

8. The method of claim 6 wherein the step of transmitting the measured result includes measuring quality of the inter RAT cell if signal quality of a serving cell is less than a signal quality threshold value for measuring signal quality of the WiMAX cell or if receiving power strength of the serving cell is less than receiving power threshold value for measuring receiving power of the WiMAX cell.

9. The method of claim 6, wherein the step of pre-registering with the target base station includes pre-registering with the target base station if signal quality of a serving cell is less than a pre-registration signal quality threshold value or if receiving power strength of the serving cell is less than pre-registration receiving power threshold value.

10. A method for inter RAT handover, the method comprising:
measuring cell quality of MAX neighbor cells from a user equipment of E-UTRAN and transmitting the measured result to an origin base station;
if handover initiate command, which includes ID of a target base station, is received from the origin base station and the target base station is the base station with which the user equipment has been pre-registered, transmitting a handover preparation complete message to the origin base station; and
if the handover preparation complete message is received from the origin base station, performing an initial access procedure with the target base station.

11. The method of claim 10, wherein the handover initiate command and the handover preparation complete message include identifier of the user equipment, which is given from a cell managed by the origin base station.

12. The method of claim 10, wherein the step of transmitting the handover preparation complete message to the origin base station includes pre-registering with the target base station using tunneling based on second layer protocol if the target base station is not the base station with which the user equipment has been pre-registered.

13. The method of claim 10, wherein the step of transmitting the handover preparation complete message to the origin base station includes pre-registering with the target base station through an inter RAT access node using tunneling based on third layer protocol if the target base station is not the base station with which the user equipment has been pre-registered.

14. The method of claim 10, wherein the step of transmitting the handover preparation complete message to the origin base station includes:
transmitting a handover request message to an inter RAT access node using tunneling based on third layer protocol if the target base station is not the base station with which the user equipment has been pre-registered; and
pre-registering with the target base station by transmitting a handover indication message to the inter RAT access node if a handover response message is received from the inter RAT access node.

15. The method of claim 10, wherein the step of performing an initial access procedure includes disconnecting from the serving cell and synchronizing with the target base station if a handover preparation complete acknowledgement message is received.
